(19) United States
(12) Patent Application Publication
(10) Pub. No.: US 2026/0124565 A1
(43) Pub. Date: May 7, 2026

(54) FILTER MEDIA AND LIQUID FILTERS

(71) Applicant: DelStar Technologies, Inc., Alpharetta, GA (US)

(72) Inventors: Ashish Bandekar, Middletown, DE (US); John Cox, Middletown, DE (US); Andrew G. Platt, Middletown, DE (US)

(21) Appl. No.: 19/379,487

(22) Filed: Nov. 4, 2025

Related U.S. Application Data
(60) Provisional application No. 63/717,795, filed on Nov. 7, 2024.

(51) Int. Cl. B01D 39/16; B01D 17/04; B01D 39/20

(52) U.S. Cl. CPC B01D 39/1623; B01D 17/045; B01D 39/2017; B01D 2239/0622; B01D 2239/0627; B01D 2239/065; B01D 2239/1216; B01D 2239/1233; B01D 2239/1291

(57) ABSTRACT

Filter media and liquid filters are described herein. A filter media comprises a first layer, a second layer disposed adjacent the first layer, and a third layer disposed adjacent the second layer such that the second layer is interposed between the first layer and the second layer. The first layer comprises melt blown fibers, the second layer comprises microglass fibers and the third layer comprises spunbond fibers. The filter media has a relatively high filter life and a filtration efficiency of greater than or equal to about 95% without a substantial increase in pressure over time. The filter media may be particularly useful in separating a discontinuous liquid phase, such as water, from a continuous liquid phase of the solution, such as a hydrocarbon, in fuel tank storage, fuel transportation and/or oil purification applications.

### CROSS-REFERENCE TO RELATED APPLICATIONS

This application claims the benefit of U.S. Provisional Application Serial No. 63/717,795, filed November 7, 2024, the complete disclosure of which is incorporated herein by reference for all purposes.

### TECHNICAL FIELD

The following description generally relates to filter media for liquid filters and more particularly, to filter media configured to separate a discontinuous liquid phase from a continuous liquid phase.

### BACKGROUND

Conventional filters may often include or incorporate coalescers or coalescing media to separate an immiscible liquid, or “discontinuous phase”, suspended, dispersed, or otherwise disposed in another liquid, or “continuous phase”, from one another. For example, conventional filters may often include the coalescer to remove or separate water or moisture (i.e., the discontinuous phase) from petroleum based fuels (i.e., the continuous phase) to improve the operation of and/or to prevent damage to downstream systems and processes. Generally, the coalescers are capable of capturing small droplets of the discontinuous or dispersed phase from the continuous phase, coalescing the small droplets into relatively larger droplets, and separating the coalesced discontinuous phase from the continuous phase via gravitational forces. While conventional coalescers are generally effective for separating the discontinuous phase from the continuous phase, recent trends have been directed to further improve the effectiveness and/or durability of the coalescers to thereby improve the performance and/or lifetime thereof.

### SUMMARY

This following is intended merely to introduce a simplified summary of some aspects of one or more implementations of the subject matter discussed herein. Further areas of applicability of the subject matter will become apparent from the detailed description provided hereinafter. This summary is not an extensive overview, nor is it intended to identify key or critical elements of the teachings herein, nor to delineate the scope of the subject matter. Rather, its purpose is merely to present one or more concepts in simplified form as a prelude to the detailed description below.

Filter media and liquid filters are described herein. The filter media may be particularly useful in separating a discontinuous liquid phase, such as water, from a continuous liquid phase of the solution, such as a hydrocarbon, in fuel tank storage, fuel transportation or oil purification applications.

In one aspect, a filter media may include a first layer comprising melt blown polymer fibers, a second layer comprising microglass fibers and a third layer comprising spunbond polymer fibers. The first layer is disposed adjacent a first surface of the second layer and the third layer is disposed adjacent a second opposing surface of the second layer.

The filter media has a relatively high filter life and a filtration efficiency of greater than or equal to about 95%, or greater than about 99%, without a substantial increase in pressure over time. In addition, the replacement time between two filters is reduced due to improved performance in relation to pressure, which reduces corrosion, foaming, clogging and other factors that could reduce the effectiveness of the filter.

In embodiments, the polymer of the melt blown fibers may be a polyamide.

In embodiments, the polyamide of the melt blown fibers may be nylon.

In embodiments, the first layer may have a thickness of from about 5 mils to about 15 mils, or about 10 mils.

In embodiments, the first layer may have an air permeability of from about 50 ft³/ft²/min to about 150 ft³/ft²/min, or from about 90 ft³/ft²/min to about 110 ft³/ft²/min, or about 100 ft³/ft²/min.

In embodiments, the first layer may have a basis weight of from about 10 gsm to about 50 gsm, or about 30 gsm to about 40 gsm, or about 34 gsm.

In embodiments, the first layer may have a mean flow pore size of from about 10 µm to about 30 µm, or from about 18 µm to about 22 µm, or about 20 µm.

In embodiments, the plurality of microglass fibers of the second layer may include a combination of coarse microglass fibers and fine microglass fibers.

In embodiments, the plurality of microglass fibers may be wetlaid microglass fibers.

In embodiments, the plurality of microglass fibers may include bicomponent fibers.

In embodiments, the second layer may have a thickness of from about 5 mils to about 15 mils, or about 10 mils.

In embodiments, the second layer may have an air permeability of from about 10 ft³/ft²/min to about 70 ft³/ft²/min, or from about 40 ft³/ft²/min to about 45 ft³/ft²/min, or about 42 ft³/ft²/min.

In embodiments, the second layer may have a basis weight of from about 30 gsm to about 80 gsm, or about 50 gsm to about 60 gsm, or about 54 gsm.

In embodiments, the polymer of the plurality of spunbond fibers may be a polyamide.

In embodiments, the polyamide of the plurality of spunbond fibers may be nylon.

In embodiments, the third layer may have a basis weight of from about 5 gsm to about 35 gsm, or from about 15 gsm to about 25 gsm, or about 20 gsm.

In embodiments, the first, second, and third layers of the filter may be ultrasonically bonded with one another.

In embodiments, the filter may be configured to separate a discontinuous liquid phase of a solution from a continuous liquid phase of the solution.

In embodiments, the filter may have a filtration efficiency of greater than or equal to about 95% or about 99% according to reference test ISO 16332 of the International Organization for Standards.

In another aspect, a device for separating a discontinuous liquid phase of a solution from a continuous liquid phase of the solution is provided comprising the filter media described above. The discontinuous liquid phase may comprise water.

In another aspect, a liquid filter is provided comprising the filter media described above.

In another aspect, a mechanical coalescer is provided comprising the filter media described above.

In another aspect, a hydrocarbon liquid filter is provided comprising the filter media described above.

In another aspect, a liquid filter media comprises one or more layers configured to separate a discontinuous liquid phase of a solution from a continuous liquid phase of the solution. The filter media has a filtration efficiency of greater than or equal to about 95% according to reference test ISO 16332 of the International Organization for Standards and pressure increase of less than about 10%.

In embodiments, the filter media has a filtration efficiency of greater than or equal to about 99% according to reference test ISO 16332 of the International Organization for Standards.

In embodiments, the pressure increase is less than about 5%, or less than about 1%, or less than about 0.1%.

In embodiments, the one or more layers comprises a first layer comprising melt blown fibers, a second layer disposed adjacent the first layer and comprising microglass fibers and a third layer disposed adjacent the second layer such that the second layer is interposed between the first layer and the second layer, the third layer comprising spunbond fibers.

In embodiments, the melt blown fibers comprise a polyamide.

In embodiments, the spunbond fibers comprise a polyamide.

The foregoing and/or other aspects and utilities described herein may be achieved by providing a device for separating a discontinuous liquid phase of a solution from a continuous liquid phase of the solution. The device may include any one of the foregoing filters.

The foregoing and/or other aspects and utilities described herein may be achieved by providing a method for separating a discontinuous liquid phase of a solution from a continuous liquid phase of the solution. The method may include directing the solution to and through any one of the forgoing filters. The method may also include coalescing relatively small droplets of the discontinuous liquid phase with one another in the filter to form relatively large droplets of the discontinuous phase. The method may further include collecting the discontinuous liquid phase downstream of the third layer of the filter via gravitational forces to thereby separate the discontinuous liquid phase of the solution from the continuous liquid phase of the solution.

Further areas of applicability of the subject matter will become apparent from the detailed description provided hereinafter. It should be understood that the detailed description and specific examples, while indicating some typical aspects of the subject matter, are intended for purposes of illustration only and are not intended to limit the scope thereof.

The recitation herein of desirable objects which may be met by various embodiments of the description is not meant to imply or suggest that any or all of these objects may be present as essential features, either individually or collectively, in the most general embodiment of the description or any of its more specific embodiments.

### BRIEF DESCRIPTION OF THE DRAWINGS

The accompanying drawings, which are incorporated in and constitute a part of this specification, illustrate several embodiments of the subject matter and, together with the description, serve to explain the principles thereof.

FIG. 1 illustrates an exemplary filter; and

FIG. 2 is a plot of filter efficiencies and change in pressure from Example 1.

### DETAILED DESCRIPTION

This description and the accompanying drawings illustrate exemplary embodiments and should not be taken as limiting, with the claims defining the scope of the present, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically included all the possible subranges as well as individual numerical values within that range. As such, any value within the range may be selected as the terminus of the range. For example, description of a range such as from 1 to 5 should be considered to have specifically included subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ± 0.01% (inclusive), ± 0.1% (inclusive), ± 0.5% (inclusive), ± 1% (inclusive) of that numeral, ± 2% (inclusive) of that numeral, ± 3% (inclusive) of that numeral, ± 5% (inclusive) of that numeral, ± 10% (inclusive) of that numeral, or ± 15% (inclusive) of that numeral. It should further be appreciated that when a numerical range is discussed herein, any numerical value falling within the range is also specifically included.

As used herein, “free” or “substantially free” of a material may refer to a composition, component, or phase where the material is present in an amount of less than 10.0 wt%, less than 5.0 wt%, less than 3.0 wt%, less than 1.0 wt%, less than 0.1 wt%, less than 0.05 wt%, less than 0.01 wt%, less than 0.005 wt%, or less than 0.0001 wt% based on a total weight of the composition, component, or phase.

All references cited herein are hereby incorporated by reference in their entireties. In the event of a conflict in a definition with a cited reference, the teachings control.

Filters or filter media, nonwoven sheet or textiles thereof, and/or fibers thereof are described. As used herein, the terms “filter” and “coalescer” are utilized interchangeably. Similarly, the expression “filter media” and “coalescing media” are utilized interchangeably. The filters, the nonwoven sheets, and/or the fibers thereof may be utilized in filters and/or filter devices. Illustrative filters may be or include, but are not limited to, oil and gas filters, filters for engines, filters for fuel tank storage, filters for fuel transportation and oil purification, or the like. Systems and methods for manufacturing the filters, the nonwoven sheets thereof, and/or the fibers thereof are also described.

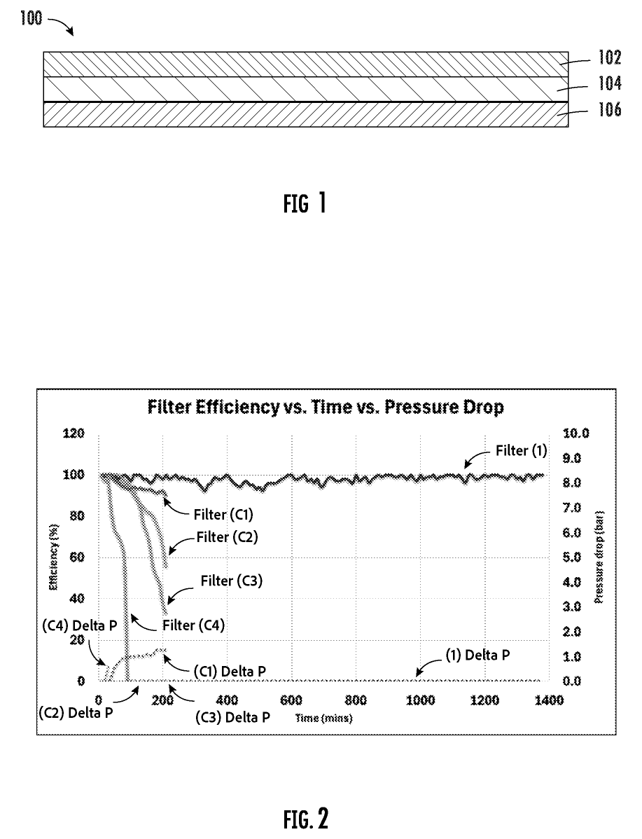

FIG. 1 illustrates an exemplary filter 100, according to one or more implementations. The filter 100 may be capable of or configured to separate a first fluid, or a discontinuous/dispersed phase, and a second fluid, or continuous phase, from one another. For example, the filter 100 may be capable of or configured to separate water (“discontinuous phase”) dispersed or otherwise disposed in a petroleum-based fuel (“continuous phase”) from the petroleum-based fuel. Similarly, the filter 100 may also be capable of or configured to separate the petroleum-based fuel (“discontinuous phase”) from the water (“continuous phase”). As further described herein, the filter 100 may be capable of or configured to separate the discontinuous phase and continuous phase from one another without increasing pressure across or through the filter. The filter 100 may also be capable of or configured to filter at an efficiency of greater than or equal to about 99.9% for a period of at least 23 hours.

The filter 100 may include one or more layers or non-woven sheets. As used herein, the expression “layer” and “non-woven sheet” are utilized interchangeably. For example, the filter 100 may include one, two, three, four, five, or more layers or non-woven sheets. In an exemplary implementation, the filter 100 includes at least three layers. For example, the filter 100 may include a first layer 102, a second layer 104, and a third layer 106. As illustrated in FIG. 1, the first and second layers 102, 104 may be disposed adjacent to one another (e.g., directly adjacent), and the third layer 106 may be disposed adjacent the second layer 104 such that the second layer 104 is interposed between the first layer 102 and the second layer 106.

In at least one implementation, each of the layers or non-woven sheets 102, 104, 106 may include a plurality of fibers. In at least one implementation, the respective fibers in one or more of the layers 102, 104, 106 may be dissimilar with the fibers in one or more of the remaining layers 102, 104, 106. For example, the fibers of the first layer 102 may be dissimilar to the fibers in the second layer 104 and/or the third layer 106. In another implementation, the respective fibers in one or more layers 102, 104, 106 may be similar or the same as the fibers in one or more of the remaining layers 102, 104, 106. For example, the fibers of the first layer 102 may be the same as the fibers in the second layer 104 and/or the third layer 106.

The fibers of any one or more of the layers 102, 104, 106 may be or include artificial fibers, natural fibers, or a combination thereof. The fibers of any one or more of the layers 102, 104, 106 may be or include hydrophilic fibers, hydrophobic fibers, or a combination thereof. For example, the respective fibers of the first layer 102, the second layer 104, and the third layer 106 may be hydrophilic fibers. In another example, at least one of first, second, and third layers 102, 104, 106 may include hydrophobic fibers. In yet another example, at least one of the first, second, and third layers 102, 104, 106 may include a combination of hydrophobic and hydrophilic fibers. In an exemplary implementation, the fibers of the first, second, and third layer 102, 104, 106, are hydrophilic fibers capable of or configured to exhibit a strong tendency to bind or absorb water. As used herein, a fiber may be hydrophilic when its water contact angle is less than 90°, less than 50°, less than 30°, less than 10°, less than 5°, less than 1°, or less. Illustrative hydrophilic fibers may be or include, but are not limited to, glass fibers, mineral fibers (e.g., alumina, titania, silica, etc.), metal fibers (e.g., aluminum and alloys thereof), one or more polymers (e.g., cellulose acetate, polymethylmethacrylate, polyethylene oxide, nylon, etc.), or the like, or any combination thereof. In some implementations, at least some of the hydrophilic fibers include hydrophilic polymers that may absorb or swell with water.

The fibers of any one or more of the layers 102, 104, 106 may be prepared, fabricated, or manufactured via any system and method known in the art, including, but not limited to, melt spinning, wet spinning, dry spinning, melt blowing, spunbonding, spun lacing, head bonding, carding, air-laid, wet-laid, extrusion, co-formed, stitched, hydraulically entangled, or the like, or any combination thereof. The foregoing and additional systems and methods for preparing the fibers are described in United States Patent Nos. 4,406,950, 6,338,814, 6,616,435, 6,861,142, 7,252,493, 7,300,272, 7,309,430, 7,422,071, 7,431,869, 7,504,348, 7,774,077 9,522,357, 9,993,761, and United States Patent Publication No. 2009/0266759, the disclosures of which are incorporated herein by reference to the extent consistent with the description.

In at least one implementation, the fibers of any one or more of the layers 102, 104, 106 may be prepared or fabricated from, may be, or may include, but are not limited to, one or more polymers, one or more resins, copolymers thereof, or any combination thereof. Illustrative polymers and resins may be or include, but are not limited to, one or more of an olefin, an acrylate, a polyester, a polyethylene naphthalate (PEN) a polyester, a polycyclohexylene dimethylene terephthalate (PCT) polyester, a polypropylene (PP), a polybutylene terephthalate (PBT) polyester, a co-polyamides, a polyethylene, a high density polyethylene (HDPE), a linear low density polyethylene (LLDPE), a cross-linked polyethylene, a polycarbonate, a polyacrylate, a polyacrylonitrile (PAN), a polyfumaronitrile, a polymer prepared from fumaronitrile, a polystyrene (PS), a styrene maleic anhydride, a polymethylpentene, a cyclo-olefinic copolymer, a fluorinated polymer, a polytetrafluoroethylene, a polyolefin, a thermoplastic liquid crystalline polymer, a polyimide (PI), Kevlar®, a polyether ketone, a cellulose ester, a cotton, a ramie, a chitosan, wool, a cuprammonium rayon (cupro), a Lyocell, nylon, a polyamide, silk, a polyether-polyurea copolymers, LYCRA, an elastane, a polymethacrylic polymer, a poly(methyl methacrylate), a polyoxymethylene, a polysulfonate, a modacrylic, a styrenated acrylic, a pre-oxidized acrylic, a fluorinated acrylic, a vinyl acetate, a vinyl acrylic, an ethylene vinyl acetate, a styrene-butadiene, an ethylene/vinyl chloride, a vinyl acetate copolymer, a latex, a polyester copolymer, a carboxylated styrene acrylic, a vinyl acetate, an epoxy, an acrylic multipolymer, a phenolic, a polyurethane, a cellulose, a polytetrafluoroethylene (PTFE), a polytrimethylene terephthalate, a polyethylene, an aliphatic polyester, a thermoplastic polyacrylonitrile (PAN), a styrene, a copolymer thereof, or the like, or any combination thereof. It should be appreciated that other polymers conventionally utilized for fibers are contemplated.

In an exemplary implementation, the fibers in at least one of the layers 102, 104, 106 may be or include nylon. It should be appreciated by those having ordinary skill in the art that Nylon (CAS: 63428-83-1) may be a generic name for a family of polyamide polymers characterized by the presence of an amide group –CONH and having the general formula (C₆H₁₁NO)n. Nylon may be or include a relatively long-chain synthetic polymeric amide having recurring amide groups as an integral part of the main polymeric chain. Nylon, as used herein, may refer to any type of nylon, including, but not limited to, nylon 6, nylon 66, nylon 4, nylon 9, nylon 11, nylon 12, or the like, or any combination thereof. Nylon may be a thermoplastic polymer having relatively high elasticity. Nylon 66 may be a condensation product of adipic acid and hexamethylenediamine. Nylon 6 may be a polymer of caprolactam. Nylon 4 may be a polymer based on butyrolactam (2-pyrrolidone). It should be appreciated that not all nylons are polyamide resins. Similarly, not all polyamide resins are nylons (e.g., Versamide). For example, at least one class of polyamide resins distinct from nylon is derived from ethylenediamine, and may be liquid or a low-melting solid, and have a relatively lower molecular weight than nylon. In another example, another class of polymers is called aramids, and is aromatic in nature, as opposed to nylons.

In at least one implementation, the fibers prepared from one or more polymers, resins, or a combination thereof, such as nylon fibers, may have an average fiber diameter of from about 2 µm to about 10 µm, or about 3 µm to about 7µm.

In at least one implementation, the fibers prepared from one or more polymers, resins, or a combination thereof, such as nylon fibers, may have an average length of from about 5 cm to about 20 cm, or about 8 cm to about 10 cm.

In at least one implementation, the fibers prepared from one or more polymers, resins, or a combination thereof, such as nylon fibers, may have an aspect ratio or a ratio of length to diameter of from about 100 to 20,000.

In at least one implementation, the fibers of any one or more of the layers 102, 104, 106 may be prepared or fabricated from, may be, or may include, but are not limited to, glass. The glass or glass fibers may be or include, but are not limited to, sodium glass, boron glass, phosphate glass, B-glass, A-glass, C-glass, E-glass, AE-glass, S glass, or the like, or any combination thereof. The glass fibers may be prepared as a web, such as a wetlaid glass web or a drylaid glass web. The glass fibers may be microglass fibers, chopped strand glass fibers, or a combination thereof. It should be appreciated that chopped strand glass fibers and microglass fibers may be distinguished via known techniques, such as optical microscopy, electron microscopy, or the like. In an exemplary implementation, the fibers of at least one of the layers 102, 104, 106 includes at least microglass fibers. The microglass fibers may include from about 10 to about 15% alkali (e.g., sodium, magnesium oxides), and may have a relatively lower melting and processing temperature than chopped strand glass fibers. The microglass fibers may be drawn from bushing tips and further subjected to flame blowing or rotary spinning processes. The microglass fibers may be fine microglass fibers or coarse microglass fibers. Generally, fine microglass fibers may have an average diameter of from about 0.1 µm to <1 µm, about 0.2 µm to about 0.8 µm, about 0.4 µm to about 0.6 µm, or about 0.6 µm. The course microglass fibers may have an average diameter of from greater than 0.6 µm to about 10 µm, greater than or equal to about 1 µm to about 8 µm, or about 3 µm to about 6 µm.

In at least one implementation, the microglass fibers may have an average length of from about 1 m to about 11 mm.

In at least one implementation, the microglass fibers may have an aspect ratio or a ratio of length to diameter of from about 100 to 10,000.

In at least one implementation, the fibers of any one or more of the layers 102, 104, 106 may be or include multicomponent or bicomponent fibers prepared from two or more materials. For example, the fibers may be or include bicomponent fibers prepared from a first polymer and a second polymer. In another example, the fibers may be or include bicomponent fibers prepared from a polymer and glass. Multicomponent and bicomponent fibers may be prepared according to any system and process known in the art. For example, the multicomponent and bicomponent fibers may be formed by extruding two or more polymers from the same spinneret with the polymers contained within the same filament.

In at least one implementation, the fibers of at least one of the layers 102, 104, 106 includes a combination or blend of coarse microglass fibers and fine microglass fibers. In a preferred implementation, the fibers of at least one of the layers 102, 104, 106 are multicomponent or bicomponent fibers including the combination of coarse and fine microglass fibers and one or more polyesters. For example, the fibers of at least one of the layers 102, 104, 106 of the filter 100 include a combination of coarse and fine microglass fibers and bicomponent polyester fibers, such as polyethylene terephthalate (PET). The bicomponent polyester fibers may have a linear mass density of from about 1 decitex (Dtex) to about 3 Dtex, about 1.5 Dtex to about 2.5 Dtex, about 2 Dtex to about 2.4 Dtex, or about 2.2 Dtex. In biocomponent fibers, the biocomponent fiber is the co-polyester sheath and polyester core. Roughly, the amount of coarse and fine micro glass fibers weight ratio is about 70:30.

In an exemplary implementation, the fibers of the first layer 102 of the filter 100 may include melt blown fibers prepared from one or more polyamides. Particularly, the first layer 102 includes melt blown fibers of nylon. The first layer 102 may include the nylon fibers in an amount of from greater than or equal to about 80 wt% to about 100 wt%, based on the total weight of the first layer 102. For example, the first layer 102 may include the nylon fibers in an amount of from about 80 wt%, about 90 wt%, about 95 wt%, or about 98 wt% to about 100 wt%, based on the total weight of the first layer 102. In an exemplary implementation, the first layer 102 includes the nylon fiber in an amount of about 95 wt%, about 98 wt%, or about 100 wt%, based on the total weight of the first layer 102.

The first layer 102 may have a thickness of from about 1 mil (about 0.0254 mm) to about 20 mil (about 0.508 mm). For example, the first layer 102 may have a thickness of from about 1 mil, about 5 mils, or about 8 mils to about 12 mils, about 15 mils, or about 20 mils. In another example, the first layer 102 may have a thickness of from about 8 mils to about 12 mils, or about 10 mils. It should be appreciated that the thickness of each of the layers 102, 104, 106 may be determined or measured according to conventional means, such as via microscopy with a high resolution film thickness monitor, which is commercially available from Ted Pella, Inc. of Redding, CA.

The first layer 102 may have an air permeability of from about 50 ft³/ft²/min to about 150 ft³/ft²/min. For example, the first layer 102 may have an air permeability of from about 50 ft³/ft²/min, about 60 ft³/ft²/min, about 70 ft³/ft²/min, about 80 ft³/ft²/min, about 90 ft³/ft²/min, or about 95 ft³/ft²/min to about 105 ft³/ft²/min, about 110 ft³/ft²/min, about 120 ft³/ft²/min, about 130 ft³/ft²/min, about 140 ft³/ft²/min, or about 150 ft³/ft²/min. Air permeability may be measured according to any conventional means. In at least one implementation, the air permeability is measured according to reference test ASTM 737 of the American Society for Testing and Materials (ASTM). For example, air permeability may be measured using a Frazier Differential Pressure Air Permeability Pressure machine. It should be appreciated that the higher the value the lower the resistance to airflow.

The first layer 102 may have a basis weight of from about 10 grams per square meter (g/m² or gsm) to about 50 gsm. As used herein, the expression “basis weight” may refer to the weight of a fiber material per unit area. For example, the first layer 102 may have a basis weight of from about 10 gsm, about 15 gsm, about 20 gsm, about 30 gsm, or about 33 gsm to about 35 gsm, about 40 gsm, about 45 gsm, or about 50 gsm. In an exemplary implementation, the first layer 102 has a basis weight of about 34 gsm.

The first layer 102 may have a mean flow pore size (MFP) of from about 10 µm to about 30 µm. As used herein, the expression “mean flow pore size” or “MFP” may refer to the pore diameter at a pressure drop at which the flow through a wetted medium is about 50% of the flow through the dry medium. The mean flow pore size may be determined according to reference test ASTM F316 and/or via bubble point testing or capillary flow porometry. For example, the first layer 102 may have a mean flow pore size of from about 10 µm, about 15 µm, or about 18 µm to about 22 µm, about 25 µm, or about 30 µm. In another example, the first layer 102 may have a mean flow pore size of from about 18 µm to about 22 µm or about 20 µm.

In all cases, water drop size distribution for the three layers was measured according to ISO 16332 (2018-04).

In an exemplary implementation, the fibers of the second layer 104 of the filter 100 may include a combination of coarse and fine microglass fibers and bicomponent polyester fibers. The fibers of the second layer 104 may be wetlaid fibers. The second layer 104 may include the fibers in an amount of from greater than or equal to about 80 wt% to about 100 wt%, based on the total weight of the second layer 104. For example, the second layer 104 may include the fibers in an amount of from about 80 wt%, about 90 wt%, about 95 wt%, or about 98 wt% to about 100 wt%, based on the total weight of the second layer 104. In an exemplary implementation, the second layer 104 includes the fiber in an amount of about 95 wt%, about 98 wt%, or about 100 wt%, based on the total weight of the second layer 104.

The second layer 104 may have a thickness of from about 1 mil (about 0.0254 mm) to about 20 mil (about 0.508 mm). For example, the second layer 104 may have a thickness of from about 1 mil, about 5 mils, or about 8 mils to about 12 mils, about 15 mils, or about 20 mils. In another example, the second layer 104 may have a thickness of from about 8 mils to about 12 mils, or about 10 mils.

The second layer 104 may have an air permeability of from about 10 ft³/ft²/min to about 70 ft³/ft²/min. For example, the second layer 104 may have an air permeability of from about 10 ft³/ft²/min, about 20 ft³/ft²/min, about 30 ft³/ft²/min, about 35 ft³/ft²/min, or about 40 ft³/ft²/min to about 45 ft³/ft²/min, about 50 ft³/ft²/min, about 55 ft³/ft²/min, about 60 ft³/ft²/min, about 65 ft³/ft²/min, or about 70 ft³/ft²/min. In an exemplary implementation, the second layer 104 may have an air permeability of from about 40 ft³/ft²/min to about 45 ft³/ft²/min, or about 42 ft³/ft²/min.

The second layer 104 may have a basis weight of from about 30 grams per square meter (g/m² or gsm) to about 80 gsm. For example, the second layer 104 may have a basis weight of from about 30 gsm, about 35 gsm, about 40 gsm, about 45 gsm, or about 50 gsm to about 60 gsm, about 65 gsm, about 70 gsm, about 75 gsm, or about 80 gsm. In an exemplary implementation, the second layer 104 has a basis weight of from about 50 gsm to about 60 gsm, or about 54 gsm.

In an exemplary implementation, the fibers of the third layer 106 of the filter 100 may include spunbond fibers prepared from one or more polyamides (PAs). Particularly, the third layer 106 may include spunbond fibers of nylon. The third layer 106 may include the spunbond nylon fibers in an amount of from greater than or equal to about 80 wt% to about 100 wt%, based on the total weight of the third layer 106. For example, the third layer 106 may include the spunbond nylon fibers in an amount of from about 80 wt%, about 90 wt%, about 95 wt%, or about 98 wt% to about 100 wt%, based on the total weight of the third layer 106. In an exemplary implementation, the third layer 106 includes the spunbond nylon fibers in an amount of about 95 wt%, about 98 wt%, or about 100 wt%, based on the total weight of the third layer 106.

The third layer 106 may have a thickness of from about 1 mil (about 0.0254 mm) to about 30 mil (about 0.762 mm). For example, the third layer 106 may have a thickness of from about 3.3mil to about 5.5 mils. In all cases throughout the description, thickness was measured according to ASTM 737.

The third layer 106 may have an air permeability of from about 652 ft³/ft²/min to about 981ft³/ft²/min. For example, the third layer 106 may have an air permeability of from about _652 ft³/ft²/min to about 981 ft³/ft²/min.

The third layer 106 may have a basis weight of from about 5 grams per square meter (g/m² or gsm) to about 35 gsm. For example, the third layer 106 may have a basis weight of from about 5 gsm, about 10 gsm, about 15 gsm, or about 20 gsm to about 25 gsm, about 30 gsm, or about 35 gsm. In an exemplary implementation, the third layer 106 has a basis weight of from about 15 gsm to about 25 gsm, or about 20 gsm.

In at least one implementation, the filter 100 includes the first layer 102 prepared from meltblown nylon, the second layer 104 prepared from the combination of the course and fine microglass fibers and the bicomponent polyester fibers, and the third layer 106 prepared from spunbond nylon fibers.

In at least one implementation, each of the layers 102, 104, 106 of the filter 100 and/or the respective fibers thereof may be coupled with one another. For example, each of the layers 102, 104, 106 of the filter 100 and/or the respective fibers of each of the layers 102, 104, 106 may be coupled or otherwise bonded with one another via a thermal bonding process, such as through-air bonding or calendar bonding, a mechanical bonding process, such as needle punching or hydroentanglement, a chemical bonding process, a solvent bonding process, a spun bonding process, a melt blowing process, a heat sealing process, an ultrasonic bonding process, or the like, or any combination thereof. In an exemplary implementation, the layers 102, 104, 106 are ultrasonically bonded with one another to prepare the filter 100.

The filter 100 may have an air permeability of from about 10 ft³/ft²/min to about 40 ft³/ft²/min. For example, the filter 100 may have an air permeability of from about 10 ft³/ft²/min, about 12 ft³/ft²/min, about 14 ft³/ft²/min, about 16 ft³/ft²/min, about 18 ft³/ft²/min, about 20 ft³/ft²/min, about 22 ft³/ft²/min, or about 24 ft³/ft²/min to about 26 ft³/ft²/min, about 28 ft³/ft²/min, about 30 ft³/ft²/min, about 32 ft³/ft²/min, about 34 ft³/ft²/min, about 36 ft³/ft²/min, about 38 ft³/ft²/min, or about 40 ft³/ft²/min. In an exemplary implementation, the filter 100 has an air permeability of from about 22 ft³/ft²/min to about 26 ft³/ft²/min or about 24 ft³/ft²/min.

The filter 100 may have a basis weight of from about 80 gsm to about 140 gsm. For example, the filter 100 including the first layer 102, the second layer 104, and the third layer 106 may have a basis weight of from about 80 gsm, about 90 gsm, about 100 gsm, or about 105 gsm to about 110 gsm, about 120 gsm, about 130 gsm, or about 140 gsm. In an exemplary implementation, the filter 100 has a basis weight of about 105 gsm to about 110 gsm, or about 108 gsm.

The filter 100 may have a mean flow pore size (MFP) of from about 1 µm to about 15 µm. For example, the filter 100 may have a mean flow pore size of from about 1 µm, about 3 µm, about 5 µm, about 7 µm, or about 8 µm to about 9 µm, about 10 µm, about 12 µm, about 14 µm, or about 15 µm. In another example, the filter 100 may have a mean flow pore size of from about 7 µm to about 10 µm, or about 8.4 µm.

The filter 100 may have a thickness of from about 10 mil (about 0.254 mm) to about 40 mil (about 1.016 mm). For example, the filter 100 may have a thickness of from about 10 mils, about 15 mils, about 20 mils, or about 23 mils to about 27 mils, about 30 mils, about 35 mils, or about 40 mils. In an exemplary implementation, the filter 100 may have a thickness of from about 20 mils to about 30 mils, about 23 mils to about 27 mils, or about 25 mils.

The filter 100 may have an efficiency of greater than or equal to about 90%, greater than or equal to about 92%, greater than or equal to about 94%, greater than or equal to about 96%, greater than or equal to about 98%, greater than or equal to about 99%, greater than or equal to about 99.9%, or greater than or equal to about 99.99%, or more. The efficiency of the filter 100 may be determined, at least in part, according to reference test ISO 16332 of the International Organization for Standards (ISO).

In an exemplary operation with continued reference to FIG. 1, the filter 100 may be disposed in a filtration device or system (not shown) such that the first layer 102 may be disposed upstream of the third layer 106. A sample or solution including a disperse or discontinuous phase (e.g., water) suspended in a continuous phase (e.g., petroleum fuel) may be contacted with and/or directed to the filter 100. Upon contacting the solution with the filter 100, droplets of the disperse phase adsorb on fibers of the filter 100, such as fibers of the first layer 102. The droplets adsorbed on the fiber may contact one another along the length and/or intersections of the fibers and coalesce into relatively larger droplets. The coalescing of the relatively smaller droplets continues from the upstream side (e.g., the first layer 102) to the downstream side (e.g., the third layer 104). At or proximal the downstream side or the third layer 104, the coalesced dispersed phase may collect and separate from the continuous phase due to increased drag and gravitational forces. The continuous phase may continue to flow through the device or system, and the separated disperse phase may accumulate at or proximal the downstream side (e.g., the third layer 106) of the filter 100.

The following numbered paragraphs are directed to one or more exemplary variations of the subject matter of the application:

1. A filter, comprising: a first layer comprising a plurality of melt blown fibers, the plurality of melt blown fibers comprising a polymer; a second layer disposed adjacent the first layer and comprising a plurality of microglass fibers; and a third layer disposed adjacent the second layer such that the second layer is interposed between the first layer and the second layer, the third layer comprising a plurality of spunbond fibers comprising a polymer.

2. The filter of paragraph 1, wherein the polymer of the plurality of melt blown fibers is a polyamide.

3. The filter of paragraph 2, wherein the polyamide of the plurality of melt blown fibers is nylon.

4. The filter any one of paragraphs 1 to 3, wherein the first layer has a thickness of from about 5 mils to about 15 mils.

5. The filter of any one of paragraphs 1 to 4, wherein the first layer has a thickness of about 10 mils.

6. The filter of any one of paragraphs 1 to 5, wherein the first layer has an air permeability of from about 50 ft³/ft²/min to about 150 ft³/ft²/min.

7. The filter of any one of paragraphs 1 to 6, wherein the first layer has an air permeability of from about 90 ft³/ft²/min to about 110 ft³/ft²/min.

8. The filter of any one of paragraphs 1 to 7, wherein the first layer has an air permeability of about 100 ft³/ft²/min.

9. The filter of any one of paragraphs 1 to 8, wherein the first layer has a basis weight of from about 10 gsm to about 50 gsm.

10. The filter of any one of paragraphs 1 to 9, wherein the first layer has a basis weight of from about 30 gsm to about 40 gsm.

11. The filter of any one of paragraphs 1 to 10, wherein the first layer has a basis weight of about 34 gsm.

12. The filter of any one of paragraphs 1 to 11, wherein the first layer has a mean flow pore size of from about 10 µm to about 30 µm.

13. The filter of any one of paragraphs 1 to 12, wherein the first layer has a mean flow pore size of from about 18 µm to about 22 µm.

14. The filter of any one of paragraphs 1 to 13, wherein the first layer has a mean flow pore size of about 20 µm.

15. The filter of any one of paragraphs 1 to 14, wherein the plurality of microglass fibers of the second layer comprises a combination of coarse microglass fibers and fine microglass fibers.

16. The filter of any one of paragraphs 1 to 15, wherein the plurality of microglass fibers are wetlaid microglass fibers.

17. The filter of any one of paragraphs 1 to 16, wherein the plurality of microglass fibers comprise bicomponent fibers.

18. The filter of any one of paragraphs 1 to 17, wherein the second layer has a thickness of from about 5 mils to about 15 mils.

19. The filter of any one of paragraphs 1 to 18, wherein the second layer has a thickness of about 10 mils.

20. The filter of any one of paragraphs 1 to 19, wherein the second layer has an air permeability of from about 10 ft³/ft²/min to about 70 ft³/ft²/min.

21. The filter of any one of paragraphs 1 to 20, wherein the second layer has an air permeability of from about 40 ft³/ft²/min to about 45 ft³/ft²/min.

22. The filter of any one of paragraphs 1 to 21, wherein the second layer has an air permeability of about 42 ft³/ft²/min.

23. The filter any one of paragraphs 1 to 22, wherein the second layer has a basis weight of from about 30 gsm to about 80 gsm.

24. The filter of any one of paragraphs 1 to 23, wherein the second layer has a basis weight of from about 50 gsm to about 60 gsm.

25. The filter of any one of paragraphs 1 to 24, wherein the second layer has a basis weight of about 54 gsm.

26. The filter of any one of paragraphs 1 to 25, wherein the polymer of the plurality of spunbond fibers is a polyamide.

27. The filter of paragraph 26, wherein the polyamide of the plurality of spunbond fibers is nylon.

28. The filter of any one of paragraphs 1 to 27, wherein the third layer has a basis weight of from about 5 gsm to about 35 gsm.

29. The filter of any one of paragraphs 1 to 28, wherein the third layer has a basis weight of from about 15 gsm to about 25 gsm.

30. The filter of any one of paragraphs 1 to 29, wherein the third layer has a basis weight of about 20 gsm.

31. The filter of any one of paragraphs 1 to 30, wherein the first, second, and third layers of the filter are ultrasonically bonded with one another.

32. The filter of any one of paragraphs 1 to 31, wherein the filter is configured to separate a discontinuous liquid phase of a solution from a continuous liquid phase of the solution.

33. The filter of any one of paragraphs 1 to 32, wherein the filter has a filtration efficiency of greater than or equal to about 99% according to reference test ISO 16332 of the International Organization for Standards.

34. A device for separating a discontinuous liquid phase of a solution from a continuous liquid phase of the solution, the device comprising the filter of any one of paragraphs 1 to 33.

35. A method for separating a discontinuous liquid phase of a solution from a continuous liquid phase of the solution, the method comprising: directing the solution to and through the filter of any one of paragraphs 1 to 34; coalescing relatively small droplets of the discontinuous liquid phase with one another in the filter to form relatively large droplets of the discontinuous phase; and collecting the discontinuous liquid phase downstream of the third layer of the filter via gravitational forces to thereby separate the discontinuous liquid phase of the solution from the continuous liquid phase of the solution.

### EXAMPLES

The examples and other implementations described herein are exemplary and not intended to be limiting in describing the full scope of compositions and methods described herein. Equivalent changes, modifications, and variations of specific implementations, materials, compositions, and methods may be made within the scope of the implementations or embodiments described herein, with substantially similar results.

Example 1

An exemplary filter (1) was prepared according to the foregoing description, and evaluated for its efficacy in coalescing a discontinuous phase from a continuous phase. Specifically, the exemplary filter was prepared by ultrasonically bonding a first layer of fibers, a second layer of fibers, and a third layer of fibers with one another. The first or upstream layer was prepared from meltblown nylon having a thickness of about 10 mils, an air permeability of about 100 ft³/ft²/min, a basis weight of about 34 gsm, and a mean pore size of about 20 µm. The second layer was prepared from wetlaid microglass having a thickness of about 10 mils, an air permeability of about 42 ft³/ft²/min, and a basis weight of about 54 gsm. The third or downstream layer was prepared from spunbond nylon having a basis weight of about 20 gsm. The first, second, and third layers were ultrasonically bonded with one another such that the second layer was interposed between the first and second layers. The filter, including the three layers, had an air permeability of about 24 ft³/ft²/min, a basis weight of about 108 gsm, and a mean pore size of about 8.37.

The exemplary filter was evaluated with four comparative filters (C1) -(C4) for their respective efficacy in separating water from fuel. Comparative filter (C1) was a filter commercially available from Gessner as GS100. Comparative filter (C2) was a filter commercially available from Gessner as GTA-34. Comparative filter (C3) was a filter commercially available from Cimteck Filter Media as V-30034. Comparative filter (C4) was a filter commercially available from Donaldson Filter as DBB0428.

The efficacy was evaluated according to the procedure of reference test ISO 16332 of the ISO entitled, “Diesel engines – Fuel filters – Method for evaluating fuel/water separation efficiency”. The droplet size was about 60 µm, the orifice was about 1.6 microns, the fuel flow rate was about 540 mL/min, and the water flow rate was about 0.81 mL/min. The exemplary filter (1) and the comparative filters (C1) -(C4) were evaluated for at least 23 hours. The results are illustrated in FIG. 2.

FIG. 2 illustrates a plot of filter efficiencies and change in pressure of the exemplary filter (1) and the comparative filters (C1) -(C4). The solid lines represent the performance efficiency for the respective filter, and the dotted lines represent the pressure increase or delta P (ΔP).

As illustrated in FIG. 2, the exemplary filter (1) surprisingly and unexpectedly exhibited a water separation efficiency of about 99.999% for more than 23 hours. Even more surprising and unexpected, there was no observable or measurable pressure change (i.e., increase or decrease) through the filter from the upstream side (e.g., upstream of the first layer) to the downstream side (e.g., downstream of the third layer). Specifically, the delta P remained about 0, as indicated by the dotted line. In contrast, comparative filter (C1) absorbed water for a period of time (about 200 minutes), however, at a pressure increase of about 1.5 bar, the comparative filter (C1) ceased to separate the water. As further illustrated in FIG. 2, comparative filter (C2) absorbed water; however, comparative filter (C2) also repelled water, which resulted in the water collecting on the upstream side thereof. Comparative filter (C3) absorbed and filtered water, similar to comparative filter (C2), which resulted in the water collecting on the upstream side thereof. Additionally, it was observed that the structural integrity of comparative filter (C3) was insufficient after evaluating for about 3.5 hours, as the filter ruptured during the evaluation. Comparative filter (C4) was only evaluated for about 30 minutes due to the filter rupturing during the evaluation.

In view of the foregoing, it was surprisingly and unexpectedly discovered that the exemplary filter (1), prepared according to the foregoing description, exhibited a filtration or separation efficiency significantly greater than any of the comparative filters (C1) -(C4). The filter efficiency was demonstrated for over 23 hours with no significant or detectable increase in pressure through the filter, i.e., less than about 10% or less than about 5%, less than about 1% or less than about 0.1% increase in pressure.

While the devices, systems, and methods have been described in detail herein in accordance with certain preferred implementations thereof, many modifications and changes therein may be affected by those skilled in the art. Accordingly, the foregoing description should not be construed to be limited thereby but should be construed to include such aforementioned obvious variations and be limited only by the spirit and scope of the following claims.

What is claimed is:

1. A filter media, comprising:
a first layer comprising melt blown polymer fibers;
a second layer comprising microglass fibers;
a third layer comprising spunbond polymer fibers; and
wherein the first layer is disposed adjacent a first surface of the second layer and the third layer is disposed adjacent a second opposing surface of the second layer.

2. The filter media of claim 1, wherein the filter has a filtration efficiency of greater than or equal to about 95% according to reference test ISO 16332 of the International Organization for Standards.

3. The filter media of claim 1, wherein the melt blown polymer fibers comprise a polyamide.

4. The filter media of claim 1, wherein the spunbond polymer fibers comprise nylon.

5. The filter media of claim 1, wherein the first layer has a thickness of from about 5 mils to about 15 mils.

6. The filter media of claim 1, wherein the first layer has a basis weight of from about 10 gsm to about 50 gsm.

7. The filter media of claim 1, wherein the first layer has a mean flow pore size of from about 10 µm to about 30 µm.

8. The filter media of claim 1, wherein the microglass fibers comprise a combination of coarse microglass fibers and fine microglass fibers.

9. The filter media of claim 8, wherein the fine microglass fibers have an average diameter of from about 0.2 µm to about 0.6 µm and the coarse microglass fibers have an average diameter of from greater than 0.6 µm to about 10 µm.

10. The filter media of claim 1, wherein the microglass fibers comprise about 10% to about 15% alkali.

11. The filter media of claim 1, wherein the second layer has a thickness of from about 5 mils to about 15 mils.

12. The filter media of claim 1, wherein the second layer has a basis weight of from about 30 gsm to about 80 gsm.

13. The filter media of claim 1, wherein the third layer has a basis weight of from about 5 gsm to about 35 gsm.

14. The filter media of claim 1, wherein the filter is configured to separate a discontinuous liquid phase of a solution from a continuous liquid phase of the solution.

15. A liquid filter media comprising:
one or more layers configured to separate a discontinuous liquid phase of a solution from a continuous liquid phase of the solution; and
wherein the filter has a filtration efficiency of greater than or equal to about 95% according to reference test ISO 16332 of the International Organization for Standards; and
wherein the filter has a pressure increase of less than about 10%.

16. The filter media of claim 15, wherein the pressure increase is less than about 1%.

17. The filter media of claim 15, wherein the one or more layers comprises:
a first layer comprising melt blown fibers,
a second layer disposed adjacent the first layer and comprising microglass fibers; and
a third layer disposed adjacent the second layer such that the second layer is interposed between the first layer and the second layer, the third layer comprising spunbond fibers.

18. The filter media of claim 17, wherein the microglass fibers comprise a combination of coarse microglass fibers and fine microglass fibers.

19. The filter media of claim 18, wherein the fine microglass fibers have an average diameter of from about 0.2 µm to about 0.6 µm and the coarse microglass fibers have an average diameter of from greater than 0.6 µm to about 10 µm.

20. The filter media of claim 17, wherein the microglass fibers comprise about 10% to about 15% alkali.
